(19) United States
(12) Patent Application Publication
(10) Pub. No.: US 2016/0200205 A1
(43) Pub. Date: Jul. 14, 2016

(54) CHARGING OF ROAD VEHICLES CAPABLE OF BEING BATTERY DRIVEN

(71) Applicant: SIEMENS AKTIENGESELLSCHAFT, München (DE)

(72) Inventors: Ulrich BOLIK, Bottrop (DE); MARTIN LINNHÖFER, Essen (DE)

(73) Assignee: Siemens Aktiengesellschaft, 80333 München (DE)

(21) Appl. No.: 14/913,270

(22) PCT Filed: Aug. 18, 2014
(86) PCT No.: PCT/EP2014/067561

§ 371 Date: Feb. 19, 2016

(30) Foreign Application Priority Data
Aug. 22, 2013 (DE) 10 2013 216 700.8

(51) Int. Cl. B60L 11/18; B60L 5/42

(52) U.S. Cl. CPC B60L 11/1816; B60L 11/1837; B60L 11/1838; B60L 5/42

(57) ABSTRACT

According to the invention, a road vehicle (1) capable of being battery driven drives up to a charging station (2). A control device (8) located on the road vehicle (1) brings a contact assembly (11) provided on the road vehicle (1) on an upper face (12) of said vehicle (1) into contact with contact elements (10) of the charging station (2) which are located above the road vehicle (1). The control device (8) of the road vehicle (1) transmits a switching command (S) in a cableless manner to a control device (9) located on the charging station (2). As a result of said switching command (S), the control device (9) of the charging station (2) applies a voltage to the contact elements 10) such that a charging current (I) can be fed from an alternating voltage supply system (13) to an electric energy store (6) of the road vehicle (1) via the contact elements (10) of the charging station (2), the contact assembly (11) of the road vehicle (1) and a charging current converter (14). The charging current converter (14) sets the output voltage (U) provided by said converter (14) and/or the charging current (I) in accordance with set values (U*, I*) that are predetermined for the control device (8) of the road vehicle (1).

The present invention relates to a charging method for a road vehicle capable of being battery driven.

The present invention further relates to a road vehicle capable of being battery driven and a charging station for such a road vehicle.

The present invention further relates to a vehicle system consisting of a number of road vehicles capable of being battery driven and a number of charging stations.

The term “battery driven” is already known in the case of trams and trolleybuses. In trams and trolleybuses, it is understood by the term “battery driven” that in the event of a malfunction of the electrical power supply—which is generally supplied via the overhead cable—a temporary emergency operation is possible under very restricted conditions and over very short distances, in order to drive the vehicle slowly out of a crossroads area, for example. Within the scope of the present invention, however, the term “battery driven” is not understood in this sense. Rather, it is understood that from time to time the road vehicle has to recharge its electric energy store—generally a battery—but also operates at full capacity, although the electrical drive of the road vehicle is exclusively supplied by the electric energy store during normal drive mode.

In cities there is an increasing need to reduce carbon dioxide emissions. Therefore, attempts are currently being made to provide local public transport and in some cases also delivery traffic in inner city areas with road vehicles which either travel purely electrically or are at least provided with hybrid drives in which purely battery-operated travel is also possible.

The capacity of batteries and other electric energy stores is—at least currently—not yet sufficient in order to store the quantity of power which is necessary to put the corresponding vehicles in circulation for a day, i.e. to operate the vehicles over the entire day (or at least several hours without interruption) and to recharge the electric energy store only at longer time intervals—for example overnight. Thus it is necessary to recharge the electric energy store repeatedly during the day. To this end, it is necessary to arrange charging stations for such road vehicles at a sufficient number of points in the inner city area.

Moreover, different boundary conditions exist for the charging process. Thus, for example, the charging process should be as short as possible. For this reason, a high charging power is required. The required charging power is often above 100 kW, at times even considerably above 100 kW. Moreover, preferably the vehicle driver should not have to be expected to handle cabled plug connections and the like. Firstly, for example the associated cable and plug are relatively heavy and bulky, due to the required high voltages, currents and power. Secondly, passers-by should not be put in danger in the area of the road vehicle, and as far as possible should also not be obstructed. A further feature is that the overall weight of the road vehicle is a critical factor. Therefore, the underlying principle of the charging process should be selected such that as few additional components as possible have to be installed on the road vehicle.

A system is known in which charging stations are present, at which the electrical power is supplied to the road vehicle by means of inductive power transmission. This system, however, involves risks in terms of parasitic radiation. Potential long-term damage to humans by the electromagnetic fields produced, is not to be excluded. Moreover, in this system heavy components are required on the road vehicle.

In the article “Austria is charged up” published in “Pictures of the Future” spring 2013, pages 106 and 107, a system installed in Vienna (Austria) is described in which the battery of the road vehicle is charged via the overhead cable of the tram network already present. In this case, the road vehicle has a DC/DC converter, the voltage of the overhead cable being converted thereby to the voltage of the road vehicle. This system also requires relatively heavy components on the road vehicle. For example, with a charging power of only 60 kW the DC/DC converter already has a mass of approximately 230 kg. Moreover, this concept is only able to be implemented if a tram network is already present.

Recently a system has been trialed in Geneva which implements a charging method for a road vehicle capable of being battery driven,
wherein the road vehicle drives up to a charging station,
wherein a control device arranged on the road vehicle moves a contact assembly arranged on the road vehicle on an upper face of said vehicle upwards toward contact elements which are accessible from below,
wherein a charging current is supplied into a battery of the road vehicle via the contact elements of the charging station and the contact assembly of the road vehicle.

The object of the present invention is to provide options, by means of which the boundary conditions of the charging process are able to be fulfilled in a simple manner.

The object is achieved by a charging process having the features of claim 1. Advantageous embodiments of the charging process according to the invention form the subject-matter of the dependent claims 2 to 9.

According to the invention the charging method comprises the features
that the road vehicle drives up to a charging station,
that by the control of a control device arranged on the road vehicle, a contact assembly arranged on the road vehicle on an upper face of the road vehicle and contact elements arranged above the road vehicle are brought into contact with one another,
that the control device of the road vehicle transmits a switching command in a cableless manner to a control device located on the charging station,
that as a result of the switching command, the control device of the charging station applies a voltage to the contact elements, such that a charging current is fed from an alternating voltage supply system to an electric energy store of the road vehicle via the contact elements of the charging station, the contact assembly of the road vehicle and a charging current converter, and
that the charging current converter sets an output voltage provided by the charging current converter and/or the charging current in accordance with setpoint values which are predetermined by the control device of the road vehicle.

By means of this embodiment, it is initially achieved that a risk or obstruction to passers-by is virtually eliminated. This is because the contact elements of the charging station may be arranged at a height which is considerably above the overall height of the road vehicle. In particular, the contact elements may be arranged at a height which is generally common in overhead cable systems, i.e. typically approximately 4 m to 5 m above the track height. Due to the cabled transmission of the charging current, moreover, high-frequency electromagnetic fields are not generated, so that such a risk of interference and danger is also eliminated. Due to the cabled transmission of the charging current, moreover, a high charging current and a high charging power may be produced in a simple manner. The contact assembly arranged on the road vehicle may be constructed as is generally known for consumers of trams, railways and the like. In particular, the contact assembly may be raised (i.e. driven up onto the contact elements of the charging station from below) and lowered (i.e. moved away from the contact elements of the charging station) fully automatically or semi-automatically. Also, the reverse method is possible, i.e. the contact assembly of the road vehicle is fixed relative to the road vehicle, so that the contact elements of the charging station are displaced in order to be brought into contact with one another. Also, hybrid forms are possible. For example, the contact assembly of the road vehicle may be moved in the vertical direction, but a horizontal compensation movement for accurate positioning may take place on the part of the charging station if required. In fully automatic operation, no action is required on the part of the vehicle driver, and in semi-automatic operation, for example, only pressing on a button or a comparable operation by the vehicle driver is required. Moreover—with the exception of the relatively small and lightweight control device of the road vehicle and possibly a pair of contactors—it is not required to provide additional components on the road vehicle to any great extent.

It is possible that the charging current converter is arranged in the charging station. In this case, the control device of the road vehicle preferably transmits the setpoint values predetermined thereby in a cableless manner to the control device of the charging station. In this case the control device of the charging station controls the charging current converter.

The charging current is preferably passed via the contact elements and the contact assembly both from the charging station to the road vehicle and from the road vehicle to the charging station. An earth rail or comparable device arranged on the ground is therefore not required. Preferably, however, the contact assembly of the road vehicle cooperates with the contact elements of the charging station, such that during the charging process the road vehicle is earthed and/or generally connected to a protective potential. For example, a suitable contact element of the charging station may be present therefor, which cooperates with a corresponding contact of the contact assembly.

Alternatively, it is possible that the charging current converter is arranged in the road vehicle. In this case, the control device of the road vehicle controls the charging current converter.

The road vehicle—naturally—has at least one electrical machine. The electrical machine, in drive mode of the road vehicle, is generally powered by the electric energy store of the road vehicle, by means of a traction current converter of the road vehicle. In charging mode of the road vehicle, however, preferably the traction current converter is used as a charging current converter. As a result, a component—namely the traction current converter—which is present in any case, may be used. A separate heavy charging current converter is not required. In the worst case, it is necessary for the size of the traction current converter to be slighter larger. However, this results neither in appreciably higher costs nor in an appreciably greater weight or constructional volume.

For the charging mode of the charging current converter, generally an operating inductance is required. Preferably, in charging mode, at least one winding of the electrical machine is used as an operating inductance of the charging current converter. As a result, the operating inductance may also be dispensed with. At the very least, one necessary reactor may be dimensioned to be smaller.

The alternating voltage supply system is generally a three-phase network with a plurality of phases, in particular at least three phases. Preferably, where the charging current converter is arranged on the road vehicle, in each case a separate contact element is provided for each phase. Accordingly, the contact assembly of the road vehicle has in each case a separate contact for each phase.

Further particular embodiments of the charging station are possible but not necessary. In particular, it is not necessary to provide the charging station with electrical power via a separate power supply network. The charging station may be supplied with electrical energy from the mains power network instead.

Preferably, by means of a transformer arranged in the charging station a separation may take place of the potential of the contact elements of the charging station from a power supply of the charging station.

The object is further achieved by a road vehicle capable of being battery driven, having the features of claim 10. Advantageous embodiments of the road vehicle capable of being battery driven according to the invention form the subject-matter of the dependent claims 11 to 16.

According to the invention, a road vehicle capable of being battery driven is provided,
wherein the road vehicle has an electric energy store,
wherein a contact assembly is arranged on an upper face of the road vehicle, said contact assembly being brought into contact, by the control of a control device arranged on the road vehicle, with contact elements of a charging station arranged above the road vehicle, for the road vehicle capable of being battery driven,
wherein a switching command is transmitted to a control device arranged on the charging station, in a cableless manner from the control device of the road vehicle, as a result of which the control device of the charging station applies voltage to the contact elements and feeds a charging current from an alternating voltage supply system to the electric energy store of the road vehicle via the contact elements of the charging station, the contact assembly of the road vehicle and a charging current converter,
wherein setpoint values are predetermined by the control device of the road vehicle,
wherein the charging current converter sets an output voltage provided by the charging current converter and/or the charging current, in accordance with the predetermined setpoint values.

The advantageous embodiments of the road vehicle capable of being battery driven correspond substantially with those of the charging method.

The object is further achieved by a charging station for a road vehicle capable of being battery driven, having the features of claim 17. Advantageous embodiments of the charging station according to the invention form the subject-matter of the dependent claims 18 to 24.

According to the invention, a charging station for a road vehicle capable of being battery driven is provided,
wherein the charging station has contact elements which, by the control of a control device arranged on the road vehicle, are brought into contact with a contact assembly arranged on the road vehicle on an upper face of the road vehicle,
wherein a control device arranged on the charging station receives a switching command in a cableless manner from the control device of the road vehicle,
wherein as a result of the switching command the control device of the charging station applies voltage to the contact elements such that a charging current is fed from an alternating voltage supply system to an electric energy store of the road vehicle via the contact elements of the charging station and the contact assembly of the road vehicle.

The advantageous embodiments of the charging station substantially correspond to those of the charging method. Additionally, however, further advantageous embodiments are possible.

Thus, for example, it is possible in particular that the contact elements are configured as elongated contact elements extending parallel to one another. The contact elements may, therefore, be configured in a similar manner to the overhead cable of an electric tram. In the case that the contact elements are arranged adjacent to one another or above one another, this embodiment may provide the advantage that optionally the electric energy store of a plurality of road vehicles may be charged simultaneously via the same contact elements. Moreover, this embodiment provides the advantage that the road vehicle only has to be positioned transversely relative to the contact elements. The positioning of the road vehicle is relatively uncritical in the direction of extension of the contact elements.

Moreover, it is possible that the charging station has a canopy via which the contact elements are covered over. As a result, the contact elements are protected to a considerable extent, for example from snow and rain.

The object is further achieved by a vehicle system, consisting of a number of road vehicles capable of being battery driven according to the invention, and a number of charging stations according to the invention.

The above described properties, features and advantages of this invention as well as the manner in which they may be achieved will become more clear and comparatively more comprehensible in combination with the following description of the exemplary embodiments which are described in more detail in combination with the drawings. In this case, in a schematic view:

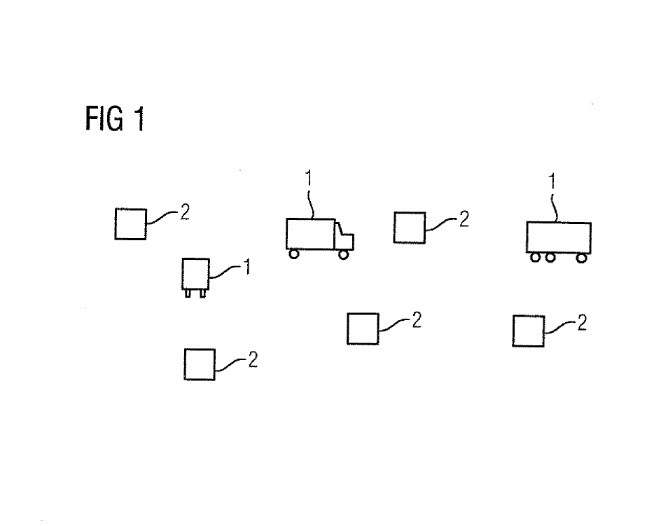

FIG. 1 shows a vehicle system,

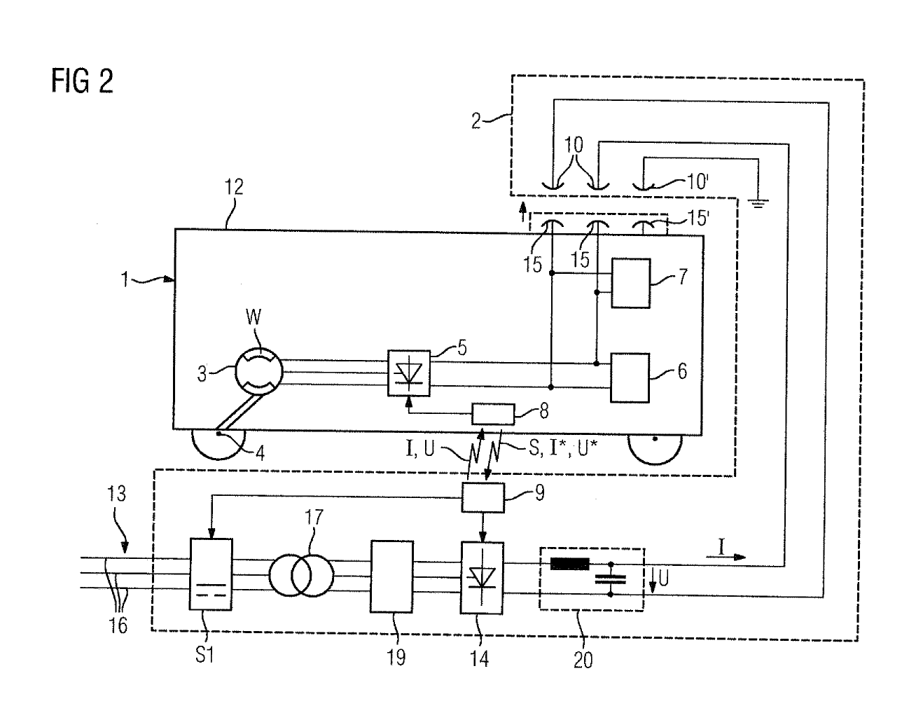

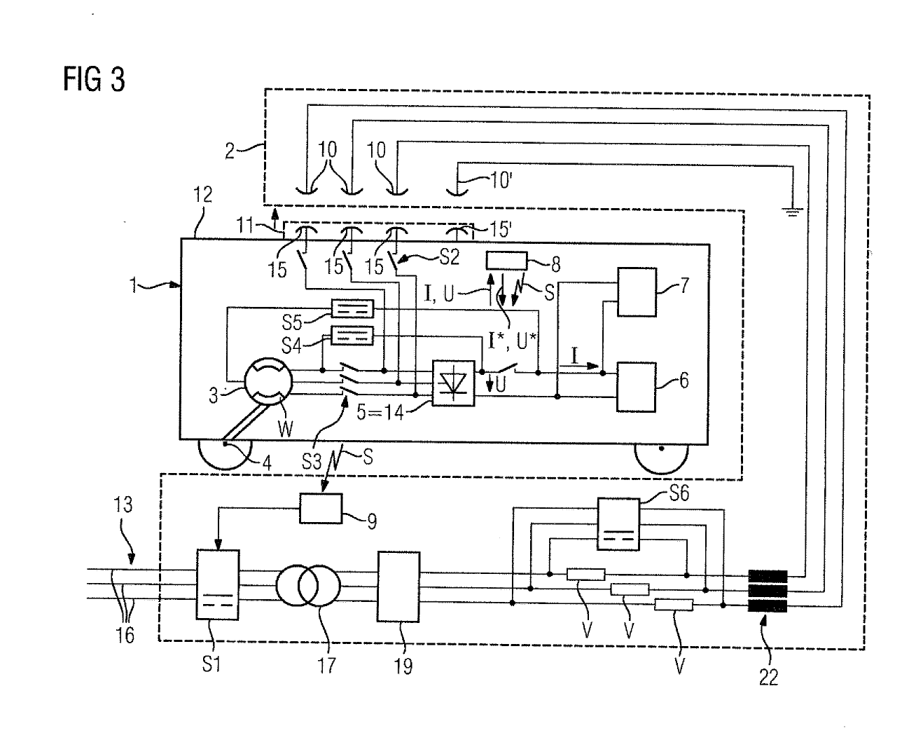

FIGS. 2 and 3 show in each case a block diagram of a charging station and a road vehicle,

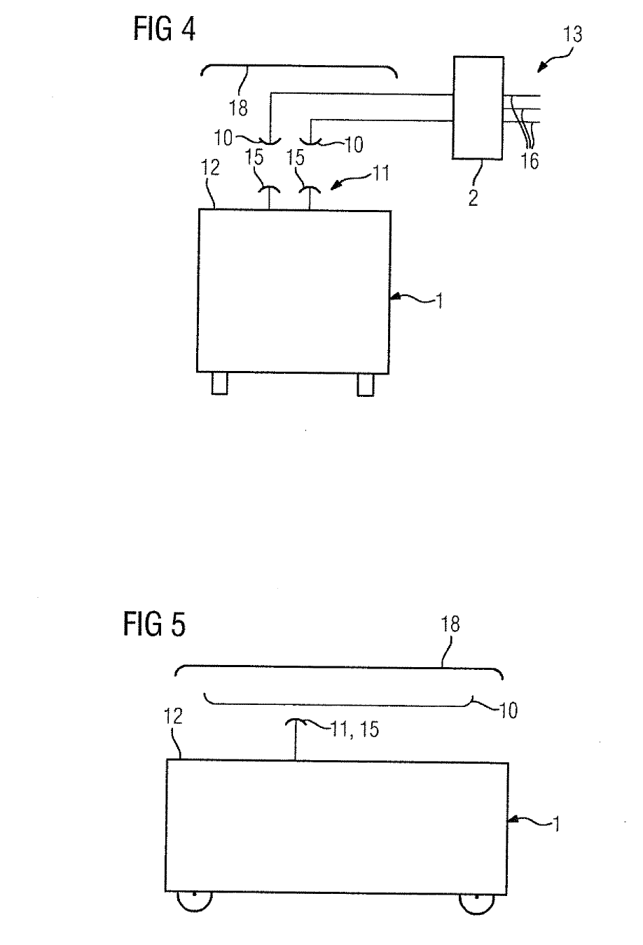

FIG. 4 shows the charging station and the road vehicle of FIG. 2 from the front,

FIG. 5 shows the charging station and the road vehicle of FIG. 2 from the side,

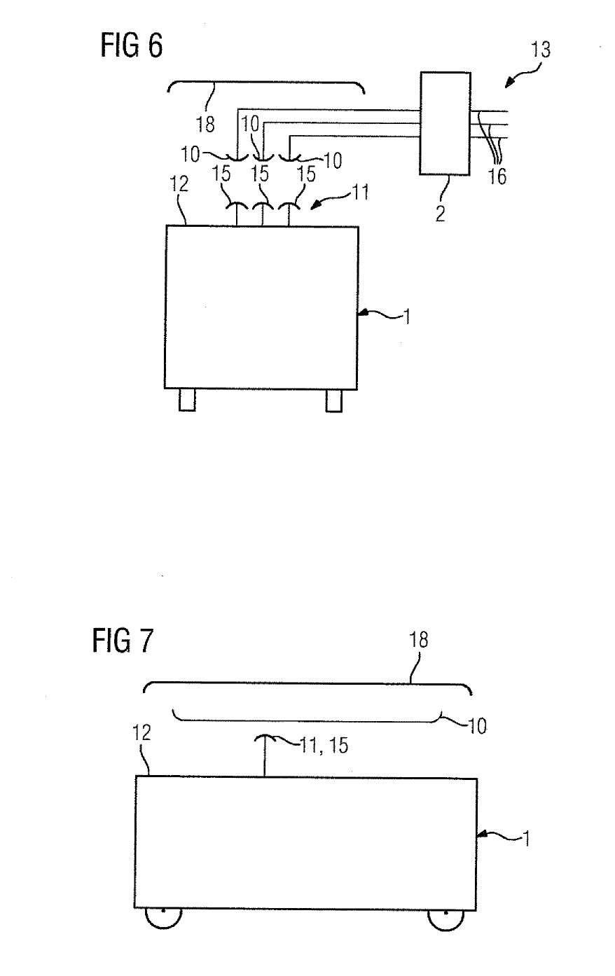

FIG. 6 shows the charging station and the road vehicle of FIG. 3 from the front,

FIG. 7 shows the charging station and the road vehicle of FIG. 3 from the side,

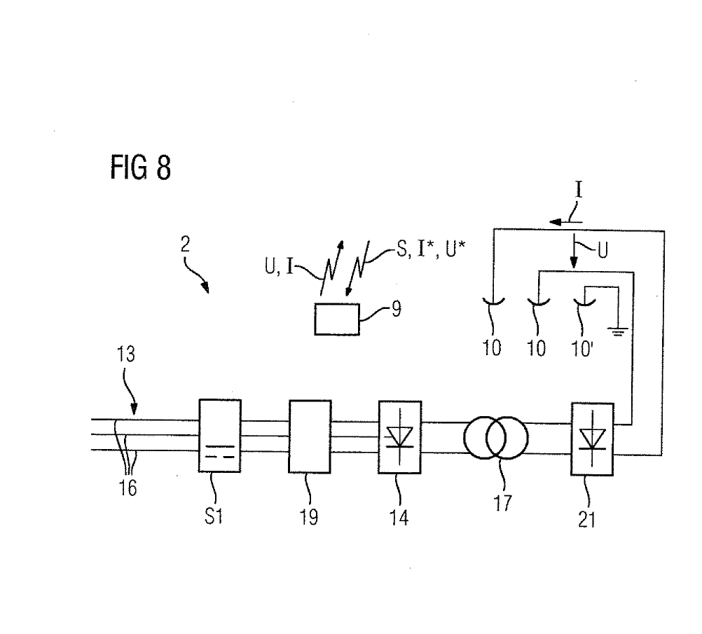

FIG. 8 shows a modification of the charging station of FIG. 2 and

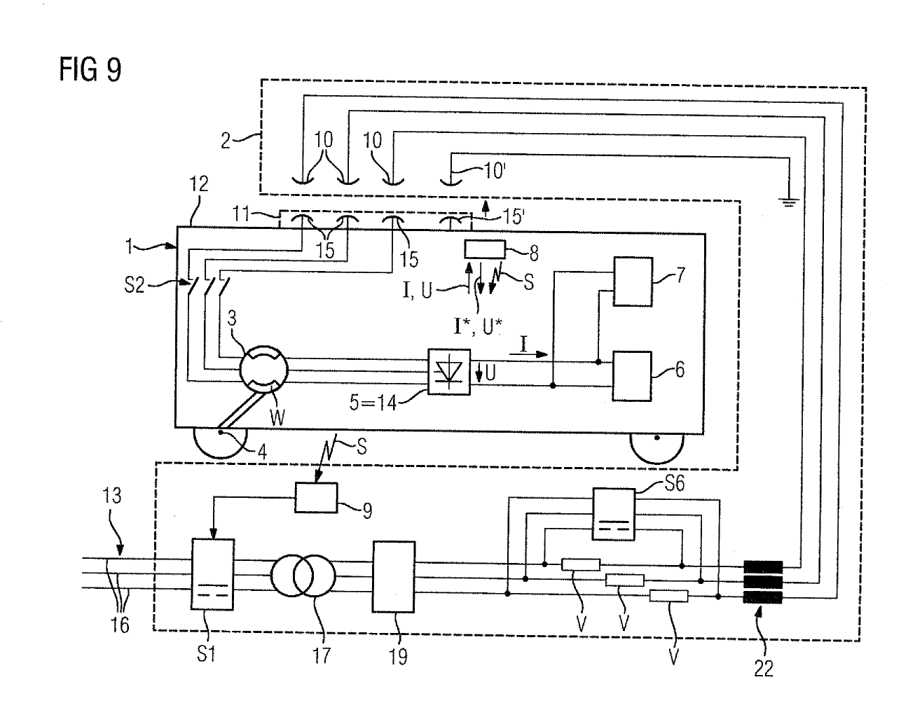

FIG. 9 shows a modification of the charging station of FIG. 3.

According to FIG. 1 a vehicle system consists of a number of road vehicles 1 and a number of charging stations 2. In principle, both the number of road vehicles 1 and the number of charging stations 2 may be of any number. Moreover, the two numbers are independent of one another. It is possible that only one individual road vehicle 1, a few road vehicles 1 or multiple road vehicles 1 form part of the system. Similarly, the number of charging stations 2 may also be varied. The road vehicles 1 are preferably utility vehicles, for example heavy goods vehicles, delivery trucks, buses and the like.

In combination with the further FIGS, in each case only one individual road vehicle 1 and in each case only one individual charging station 2 are described in more detail below. The statements, however, are also valid for the other road vehicles 1 and charging stations 2 not described in more detail.

The road vehicle 1 is capable of being battery driven. Therefore, it has—see FIGS. 2 and 3—at least one electrical machine 3 which acts in drive mode of the road vehicle 1 on a drive axle 4 of the road vehicle 1. The electrical machine 3 has at least one winding W in the stator. The winding W is generally configured to be multiphase, for example three-phase. In drive mode of the road vehicle 1, the electrical machine 3 is powered by an electric energy store 6 of the road vehicle 1 by means of a traction current converter 5. Moreover, further electrically operated devices 7 are often present, such as for example auxiliary drives, lighting systems and the like. The further electrically operated devices 7 within the scope of the present invention are of less importance and therefore not described in more detail.

In principle, the electric energy store 6 may be of any configuration, for example as a lead acid battery, Li-ion accumulator, Li-metal hydride accumulator and the like. An embodiment based on capacitive charge storage is also conceivable. Irrespective of its practical embodiment, however, the electric energy store 6 has a limited capacity. Therefore, from time to time it has to be charged up. For charging the electric energy store 6, the road vehicle 1 drives up to one of the charging stations 2. FIGS. 2 to 7 show the road vehicle 1 and the relevant charging station 2. Provided nothing further is expressly set forth, the subsequent embodiments always relate to this state in which the road vehicle 1 has driven up to the relevant charging station 2.

According to FIGS. 2 and 3, the method for charging the electric energy store 6 is as follows:

when driving the road vehicle 1 up to the charging station 2 or after the (correct) positioning of the road vehicle 1 at the charging station 2, a control device 8 of the road vehicle 1 transmits a switching command S to a control device 9 of the charging station 2. The control device 9 of the charging station 2 is arranged on the charging station 2. It receives the switching command S. The transmission from the control device 8 of the road vehicle 1 to the control device 9 of the charging station 2 takes place in a cableless manner, for example by radio. The cableless communication between the two control devices 8, 9 also applies to further information exchanged between the two control devices 8, 9.

As a result of the switching command 8, the control device 9 of the charging station 2 applies voltage to contact elements 10 of the charging station 2. For example, to this end the control device 9 of the charging station 2 may activate a contactor S1 accordingly. After the (correct) positioning of the road vehicle 1 at the charging station 2, by the control of a control device 8 of the road vehicle 1, the contact elements 10 of the charging station 2 and a contact assembly 11 of the road vehicle 1 are also brought into contact with one another. The contact elements 10 are arranged above the road vehicle 1. The contact assembly 11 is arranged on the road vehicle 1 on an upper face 12 of the road vehicle 1. Due to the activation by the control device 8 of the road vehicle 1, for example, the contact assembly 11—see a corresponding arrow in FIGS. 2 and 3—may be raised up toward the contact elements 10. The contact elements 10 in this case are accessible from below. However, other embodiments are also possible. For example, in kinematic reversal the contact elements 10—with or without positioning in the horizontal direction—may be lowered onto the contact assembly 11.

Due to the fact that voltage is applied to the contact elements 10, and the contact assembly 11 and the contact elements 10 are brought into contact with one another, a charging current I is fed into the electric energy store 6 of the road vehicle 1 from an alternating voltage supply system 13 via the contact elements 10 of the charging station 2, the contact assembly 11 of the road vehicle 1 and a charging current converter 14. The electric energy store 6 is thereby charged up. The charging current converter 14 sets an output voltage U provided by the charging current converter 14 and/or the charging current I in accordance with setpoint values U* and/or I*. The setpoint values U* and/or I* are predetermined by the control device 8 of the road vehicle 1. The control device 8 comprises to this end, i.e. for expedient predetermination of the setpoint values U* and/or I*, amongst other things the battery management system of the electric energy store 6.

The charging of the electric energy store 6 takes place in a charging mode of the road vehicle 1. The switching between drive mode and charging mode may, for example, be forcibly coupled to the raising and lowering of the contact assembly 11 (and/or generally with bringing the contact elements 10 and the contact assembly 11 together into contact and/or the separation thereof from one another). The charging mode and the drive mode of the road vehicle 1 may be locked relative to one another. In this case, a switching from drive mode to charging mode and vice versa may only take place when the road vehicle 1 is stationary. Alternatively, the drive mode may also be possible whilst the contact elements 10 and the contact assembly 11 are in contact with one another. In this case, the road vehicle 1 may also be moved during the charging process.

It is possible that a direct current flows via the contact elements 10 and the contact assembly 11. This case is shown in FIGS. 2, 4 and 5 and is described in connection with these FIG. It is alternatively possible that an alternating current flows via the contact elements 10 and the contact assembly 11. This case is shown in FIGS. 3, 6 and 7 and is described in connection with these FIGS.

In the embodiment of FIGS. 2, 4 and 5, the charging current converter 14 is arranged in the charging station 2. In this case, the control device 8 of the road vehicle 1 transmits the setpoint values U*, I* predetermined thereby initially to the control device 9 of the charging station 2. The control device 9 of the charging station 2 receives the setpoint values U*, I* and then controls the charging current converter 14. If the output voltage U and/or the charging current I are detected by the charging station 2, the control device 9 of the charging station 2 further preferably transmits the detected values U, I to the control device 8 of the road vehicle 1. Preferably, within the scope of the embodiment of FIGS. 2, 4 and 5, the charging current I is also passed via the contact elements 10 and the contact assembly 11 both from the charging station 2 to the road vehicle 1 and from the road vehicle 1 to the charging station 2. In particular, therefore, the charging station 2 in each case has at least one separate contact element 10 for both current directions. Also the contact assembly 11 has in each case at least one separate contact 15 for both current directions. Preferably, a protective contact element 10′ which is connected to a protective contact 15′ of the contact assembly 11 is also present. Via the protective contact element 10′ and the protective contact 15′ the road vehicle 1 is connected to a protective potential, generally the ground.

In the embodiment of FIG. 2, preferably, the charging current converter 14 is initially operated at a charging current I of 0. The output voltage U of the charging current converter 14 is therefore at this time preferably also 0. Only after the contact of the contact assembly 11 and the contact elements 10 does the control device 8 of the road vehicle 1 transmit a setpoint value I* which is different from 0 for the charging current I to the control device 9 of the charging station 2.

In the embodiment of FIGS. 3, 6 and 7, the charging current converter 14 is arranged in the road vehicle 1. In this case, the control device 8 of the road vehicle 1 directly controls the charging current converter 14. In theory, it is possible to provide a separate charging current converter 14 in addition to the traction current converter 5. Preferably, however, according to the view in FIG. 3, in charging mode of the road vehicle 1 the traction current converter 5 is used as charging current converter 14. In charging mode, therefore, the contact assembly 11 is electrically connected to the traction current converter 5. For example, to this end, contactors S2 and S3 may be arranged on the road vehicle 1. The contactor S2 is closed by the control device 8 of the road vehicle 1 in charging mode and otherwise—in particular in drive mode—opened. The contactor S3 is activated by the control device 8 of the road vehicle 1 in a complementary manner to the contactor S2.

For the charging mode, an operating inductance is often required. For example, according to the view in FIG. 3, the winding W of the electrical machine 3 may be used as an operating inductance of the charging current converter 14. In particular, to this end contactors 54 and S5 may be present, said contactors being closed by the control device 8 of the road vehicle 1 in charging mode and opened in drive mode.

In the embodiment of FIG. 3 the control device 8 of the road vehicle 1 transmits the switching command S preferably only after the contact assembly 11 and the contact elements 10 are brought into contact with the control device 9 of the charging station 2. Alternatively or additionally, the contact elements 10 may be provided with series resistors V, which are bridged after the contact assembly 11 and the contact elements 10 are brought into contact—for example by means of a contactor S6.

The alternating voltage supply system 13 is generally a three-phase network with several phases 16, for example three phases 16. Preferably, in the embodiment according to FIG. 3 in each case a separate contact element 11 is present for each phase 16. Thus, correspondingly, the contact assembly 11 preferably has in each case a separate contact 15 for each phase 16. Similar to the embodiment of FIG. 2, in the embodiment of FIG. 3, a protective contact element 10′ is also present and which is connected to a protective contact 15′ of the contact assembly 11. Via the protective contact element 10′ and the protective contact 15′ the road vehicle 1 is connected to the protective potential.

Both in the embodiment of FIGS. 2, 4 and 5, and in the embodiment of FIGS. 3, 6 and 7, the charging station 2 is preferably supplied with electrical power from the mains power network 13. The rated voltage of the alternating voltage supply system 13, therefore, may be 3-phase alternating voltage of 400 V or 690 V and 50 Hz or 60 Hz. Also other voltages are possible. If required, a voltage conversion may take place by means of a transformer 17. In particular—but not necessarily—in the embodiment of FIGS. 3, 6 and 7, a voltage conversion may take place to a three-phase system with 300 V rated voltage.

Preferably, the transformer 17 is always present, i.e. even when a voltage conversion is not required. In particular, the transformer 17 effects a separation of the potential of the contact elements 10 of the charging station 2 from the power supply of the charging station 2.

In the embodiment according to FIG. 3, the transformer 17, provided it is present, is configured as a three-phase transformer. Also in the embodiment according to FIG. 2, the transformer 17, provided it is present, is configured as a three-phase transformer.

In both embodiments—i.e. both in the embodiment of FIGS. 2, 4, and 5 and in the embodiment of FIGS. 3, 6 and 7—the contact elements 10, 10′ according to FIGS. 5 and 7 are preferably configured as elongated contact elements 10, 10′ extending parallel to one another. The contact elements 10, 10′ form, therefore, a so-called portion of an overhead cable system—even if relatively short. By this embodiment it may be achieved that the positioning of the road vehicle 1 in the direction of travel thereof is relatively uncritical. The contact elements 10, 10′ may be arranged, for example, at the same height adjacent to one another, at the same height behind one another or above one another.

As in particular revealed from the view of FIGS. 4 to 7, the charging station 2 also preferably has a canopy 18 by means of which the contact elements 10, 10′ are covered. It is possible that the contact elements 10, 10′ are integrated in the canopy 18.

The present invention may also be embodied in different ways.

Thus for example—see FIGS. 2 and 3—a filter 19 may be arranged upstream of the charging current converter 14. Moreover—see FIG. 2—a filter 20 may be arranged downstream of the charging current converter 14. The filter 20 may also be present in the embodiment according to FIG. 3. It is not shown there for the sake of clarity.

In the embodiment according to FIG. 2, the charging current converter 14 is connected directly or via the filter 20 to the contact elements 10. Alternatively, according to the view in FIG. 8 is possible that the charging current converter 14 is arranged upstream of the transformer 17, and the output voltage of the transformer 17 is rectified by means of a rectifier 21. In this case, the transformer 17 may be configured as a single-phase transformer. The rectifier 21 may alternatively be configured as a controlled rectifier or as diode rectifier.

In the embodiment of the charging station 2 according to FIG. 3 in charging mode the winding W is switched between the traction current converter 5 and the electric energy store 6. However, no inductors are arranged between the contacts 15 of the contact assembly 11 and the traction current converter 5. Preferably, therefore, in the embodiment according to FIG. 3 inductors 22 are arranged upstream of the contact elements 10.

FIG. 9 shows a modification of the embodiment of FIG. 3. The embodiment according to FIG. 9 corresponds substantially to the embodiment of FIG. 3. Therefore, only the differences are described in more detail below.

According to FIG. 9, in charging mode the winding W (and/or the individual winding strands thereof) is/are switched between the contacts 15 and the traction current converter 5. By a suitable division of the winding W known per se, it may be ensured that in spite of the current flux through the winding W, no torque acts on the drive axle 4. Alternatively, a mechanical brake may prevent a movement of the road vehicle 1. In the embodiment according to FIG. 9, inductors arranged upstream of the contact elements 10 are not required. However, they may be present.

Moreover, it is possible for both the road vehicles 1 and the charging stations 2 to be of a multi-system design. For example, in the case of a multi-system road vehicle 1, the road vehicle 1 may be alternatively configured, depending on the design of the charging station 2, so as to correspond to the view in FIG. 2 or 8 or so as to correspond to the view in FIG. 3 or 9. Conversely, in the case of a multi-system charging station 2, it is also possible that the charging station 2, depending on the design of the road vehicle 1, alternatively corresponding to the view in FIGS. 2 and 8 via two contact elements 10, discharges a direct current or, corresponding to the view in FIGS. 3 and 9 via three contact elements 10, discharges a three-phase current to the road vehicle 1.

It is also possible that an automatic recognition of the road vehicle 1 takes place by means of the charging station 2, so that an automated billing may be implemented. Alternatively, for example, a direct payment—for example by cash or card—is conceivable.

It is also possible to arrange position detection devices cooperating with one another on the charging station 2 and/or the road vehicle 1. As a result, it is possible for a fully automated positioning of the road vehicle 1 on the charging station 2 to take place. Alternatively, instructions for correcting the position of the road vehicle 1 may be given in automated form to the vehicle driver of the road vehicle 1. It is also possible that, within certain limits, an automatic longitudinal and/or transverse positioning of the contact elements 10 and/or the contact assembly 11 takes place.

The charging station 2 may be formed so as to be very space-efficient. The individual elements, which by necessity have to arranged above the track, are the contact elements 10. All other components—for example the contactor S1, the transformer 17, the filter 19 and, if present at the charging station 2, the charging current converter 14 and the filter 20—if required may be arranged above ground or below ground.

The present invention has many advantages. Some of these advantages are revealed below.

Thus, in particular, the charging stations 2 may be constructed without having to build additionally an infrastructure as such outside the charging stations 2. This is because the only necessary system requirement is the mains power network 13 which is present in any case in cities. Moreover, the charging stations 2, for example, may coincide with the termini of bus routes. As in particular buses (public transport vehicles) often stop for several minutes at the termini, this pause may be easily used for charging the road vehicle 1 at the same time. Moreover, all heavy components required for the charging process may be arranged outside the road vehicle 1. These components also do not have to be brought into line with the higher requirements which generally apply to road vehicles 1. Thus, for example, a protection from impact, vibration and the like is no longer required. The raising and lowering of the contact assembly 11 (=consumer) or the contact elements 10 may take place fully automatically or by pressing a button. A continuous operation by the vehicle driver or another person is not required. The voltage-conducting parts of the charging station 2 (=contact elements 11) may be arranged at the conventional height for overhead cables, so that they are not accessible to passers-by. Due to the fact that in the present invention the contact assembly 11 (=consumer) is only brought into contact with the contact elements 10 when the road vehicle 1 is stationary, the contact assembly 11 may also be constructed in a very simple manner.

The present invention therefore substantially relates to the following facts:

A road vehicle 1 capable of being battery driven drives up to a charging station 2. A control device 8 arranged on the road vehicle 1 brings a contact assembly 11, arranged on the road vehicle 1 on an upper face 12 of the road vehicle 1, into contact with contact elements 10 of the charging station 2 arranged above the road vehicle 1. The control device 8 of the road vehicle 1 transmits in a cableless manner a switching command S to a control device 9 arranged on the charging station 2. As a result of the switching command S, the control device 9 of the charging station 2 applies voltage to the contact elements 10, such that a charging current I is fed from an alternating voltage supply system 13 into an electric energy store 6 of the road vehicle 1 via the contact elements 10 of the charging station 2, the contact assembly 11 of the road vehicle 1 and a charging current converter 14. The charging current converter 14 sets an output voltage U provided by the charging current converter 14 and/or the charging current I in accordance with setpoint values U*, I* predetermined by the control device 8 of the road vehicle 1.

Although, in detail the invention has been illustrated and described more clearly by the preferred exemplary embodiment, the invention is not limited by the disclosed examples, and other variants may be derived therefrom by the person skilled in the art, without departing from the protected scope of the invention.

What is claimed is:

1.-25. (canceled)

26. A charging method for a road vehicle capable of being battery driven and having at least one electrical machine and an electric energy store to power the road vehicle in a drive mode via a traction current converter of the road vehicle, said road vehicle comprising:
driving the road vehicle to a charging station having contact elements;
bringing by control of a control device arranged on the road vehicle a contact assembly on an upper face of the road vehicle into contact with the contact elements of the charging station;
transmitting a switching command by the control device in a cableless manner to a control device arranged on the charging station;
applying by the control device of the charging station a voltage to the contact elements in response to the switching command so as to feed a charging current from an alternating voltage supply system to the electric energy store via the contact elements of the charging station, the contact assembly of the road vehicle and a charging current converter;
setting by the charging current converter an output voltage and/or the charging current in accordance with setpoint values predetermined by the control device;
using the traction current converter as the charging current converter in a charging mode of the road vehicle;
using in the charging mode a winding of the electrical machine as an operating inductance of the charging current converter;
wherein the alternating voltage supply system network is a three-phase network with a plurality of phases, with each phase having a separate one of the contact elements.

27. The charging method of claim 26, further comprising supplying the charging station with electrical energy from the mains power network.

28. The charging method of claim 26, further comprising arranging a transformer in the charging station to separate a potential of the contact elements of the charging station from an energy supply of the charging station.

29. A road vehicle capable of being battery driven, said road vehicle comprising:
an electric energy store;
a traction current converter;
at least one electrical machine having a winding and being powered by the electric energy store in a drive mode of the road vehicle via the traction current converter;
a control device configured to transmit a switching command to a control device of the charging station in a cableless manner and to provide predetermined setpoint values;
a contact assembly arranged on an upper face of the road vehicle, said contact assembly being brought into contact by control of the control device with contact elements of a charging station which is arranged above the road vehicle;
wherein in response to the switching command the control device of the charging station applies voltage to the contact elements and feeds a charging current from an alternating voltage supply system to the electric energy store via the contact elements of the charging station, the contact assembly, and a charging current converter,
said charging current converter setting an output voltage and/or the charging current as a function of the predetermined setpoint values,
said contact assembly being electrically connected to the traction current converter, so that the traction current converter operates as the charging current converter in a charging mode of the road vehicle, wherein in the charging mode the winding of the electrical machine is used as operating inductance of the charging current converter;
said alternating voltage supply system configured as a three-phase network with a plurality of phases, with the contact assembly having for each phase of the three-phase network a separate one of the contact elements.
